(19) United States
(12) Patent Application Publication
(10) Pub. No.: US 2004/0028190 A1
(43) Pub. Date: Feb. 12, 2004

(54) Condition awareness system

(76) Inventor: Brian C. Golden, Pembroke, MA (US)

Correspondence Address: Richard C. Litman, LITMAN LAW OFFICES, LTD., P.O. Box 15035, Arlington, VA, 22215, US

(21) Appl. No.: 10/632,797

(22) Filed: Aug. 4, 2003

Related U.S. Application Data
(60) Provisional application No. 60/400,681, filed on Aug. 5, 2002.

(51) Int. Cl. H04M 11/04

(52) U.S. Cl. 379/37

(57) ABSTRACT

A condition awareness system includes at least one detector and a communication device. The detector may be communicatively connected to the communication device by a wireless communication link. The communication device may be communicatively connected to a central office by a wireline and/or wireless communication link. The central office may be communicatively connected, either wirelessly or non-wirelessly, with a plurality of other remote communication devices. The detector may include a power supply, a test switch, a reset switch, at least one sensor, a visual indicator, an audible indicator, a transmitter/receiver, an antenna, and associated electronic wiring. The communication device may include a telephone dialer, communication logic, a remote deactivator, a remote activator, memory, a microprocessor, a transmitter/receiver, and an antenna.

### CROSS-REFERENCE TO RELATED APPLICATION

This application claims the benefit of U.S. Provisional Patent Application Serial No. 60/400,681, filed Aug. 5, 2002.

### BACKGROUND OF THE INVENTION

1. FIELD OF THE INVENTION

The present invention relates generally to alarm systems and, more particularly, to a condition awareness system that places a telephone call upon detection of a predetermined condition.

2. DESCRIPTION OF RELATED ART

Alarm systems, such as car security systems, home security systems, fire alarm systems, or the like, are well known in the art. For example, fire alarm systems that employ smoke detectors have been widely used in closed structures such as houses, factories, shops, ships, aircraft, and the like, for many years. Smoke detectors are normally mounted in the ceiling in a passageway, hall, stairway, or the like, in a location where there is at least partial air flow, so that if a fire does occur, smoke will be monitored by the smoke detector, and a signal given. Most of these smoke detectors have a horn or buzzer which sounds when the smoke is detected. One of the problems with most existing alarm systems is that they are designed to alert only individuals who are present or nearby a location where a fire exists or an alarm is activated and do not notify individuals who are remote from the location of the fire or alarm. The related art is represented by the following references of interest.

U.S. Pat No. 3,588,858, issued on Jun. 28, 1971 to Thomas P. Demuth, describes a safety alarm system. The Demuth patent does not disclose a condition awareness system according to the claimed invention.

U.S. Pat. No. 4,558,181, issued on Dec. 10, 1985 to Kenneth E. Blanchard et al., describes a portable, self-contained device for monitoring a selected local area for occurrence of any one of a plurality of preselected conditions. The Blanchard et al. patent does not disclose a condition awareness system according to the claimed invention.

U.S. Pat. No. 4,862,141, issued on Aug. 29, 1989 to Robert L. Jordal, describes an integrated smoke and intrusion alarm system. The Jordal patent does not disclose a condition awareness system according to the claimed invention.

U.S. Pat. No. 4,897,862, issued on Jan. 30, 1990 to Kaneyuki Nishihara et al., describes an electronic device for generating an activation signal in response to detection of an acoustic signal having parameters within predetermined ranges. The Nishihara et al. patent does not disclose a condition awareness system according to the claimed invention.

U.S. Pat. No. 5,283,816, issued on Feb. 1, 1994 to Leo A. Gomez Diaz, describes a smoke detector. The Gomez Diaz patent does not disclose a condition awareness system according to the claimed invention.

U.S. Pat. No. 5,365,568, issued on Nov. 15, 1884 to Raymond Gilbert, describes a smoke detector with automatic dialing. The Gilbert patent does not disclose a condition awareness system according to the claimed invention.

U.S. Pat. No. 5,543,778, issued on Aug. 6, 1996 to Peter J. Stouffer, describes a home security system. The Stouffer patent does not disclose a condition awareness system according to the claimed invention.

U.S. Pat. No. 5,587,701, issued on Dec. 24, 1996 to Brian K. Hess, describes a portable alarm system. The Hess '701 patent does not disclose a condition awareness system according to the claimed invention.

U.S. Pat. No. 5,587,704, issued on Dec. 24, 1996 to Samuel T. Foster, describes an audio-visual alarm system. The Foster patent does not disclose a condition awareness system according to the claimed invention.

U.S. Pat. No. 5,673,304, issued on Sep. 30, 1997 to Larry W. Connor et al., describes an emergency programmable communication system. The Connor et al. patent does not disclose a condition awareness system according to the claimed invention.

U.S. Pat. No. 5,751,216, issued on May 12, 1998 to Junichi Narumiya, describes a projected beam-type smoke detector and receiving unit. The Narumiya patent does not disclose a condition awareness system according to the claimed invention.

U.S. Pat. No. 5,777,551, issued on Jul. 7, 1998 to Brian K. Hess, describes a portable alarm system. The Hess '551 patent does not disclose a condition awareness system according to the claimed invention.

U.S. Pat. No. 5,831,526, issued on Nov. 3, 1998 to Richard L. Hansler et al., describes an automatic hazard detector network. The Hansler et al. patent does not disclose a condition awareness system according to the claimed invention.

U.S. Pat. No. 5,838,776, issued on Nov. 17, 1998 to James E. Adkins, II et al., describes a power controller for a heating/air conditioning unit. The Adkins, II et al. patent does not disclose a condition awareness system according to the claimed invention.

U.S. Pat. No. 5,850,180, issued on Dec. 15, 1998 to Brian K. Hess, describes a portable alarm system. The Hess '180 patent does not disclose a condition awareness system according to the claimed invention.

U.S. Pat. No. 5,929,777, issued on Jul. 27, 1999 to Kevin T. Reynolds, describes a radio activated personal infrared distress beacon. The Reynolds patent does not disclose a condition awareness system according to the claimed invention.

U.S. Pat. No. 6,018,580, issued on Jan. 25, 2000 to Leonard J. Nellessen, the contents of which are incorporated herein by reference, describes a non-volatile automatic telephone dialer circuit. The Nellessen patent does not disclose a condition awareness system according to the claimed invention.

U.S. Pat. No. 6,049,273, issued on Apr. 11, 2000 to Brian K. Hess, describes a cordless remote alarm transmission apparatus. The Hess '273 patent does not disclose a condition awareness system according to the claimed invention.

U.S. Pat. No. 6,154,130, issued on Nov. 28, 2000 to Nidia M. Mondejar et al., describes a portable room safety security system. The Mondejar et al. patent does not disclose a condition awareness system according to the claimed invention.

Great Britain Patent Application Publication No. 2 227 344 A, published on Jul. 25, 1990, describes a radio operated personal attack alarm. The Great Britain '344 application does not disclose a condition awareness system according to the claimed invention.

Great Britain Patent Application Publication No. 2 229 302 A, published on Sep. 19, 1990, describes a locating system for monitoring alarm conditions within an area. The Great Britain '302 application does not disclose a condition awareness system according to the claimed invention.

Great Britain Patent Application Publication No. 2 280 295 A, published on Jan. 25, 1995, describes a portable smoke detector. The Great Britain '295 application does not disclose a condition awareness system according to the claimed invention.

World Intellectual Property Organization (WIPO) Patent Application Publication No. WO 92/10820, published on Jun. 25, 1992, describes a portable smoke alarm that registers smoke where smoke will first be collected, continuously controls and/or replaces a battery, and prevents the user from forgetting the smoke alarm when leaving the area around the smoke alarm. The WIPO '820 application does not disclose a condition awareness system according to the claimed invention.

None of the above inventions and patents, taken either singly or in combination, is seen to describe the instant invention as claimed.

### SUMMARY OF THE INVENTION

A condition awareness system according to the invention includes at least one detector and a communication device. The detector may be communicatively connected to the detector by a wireless communication link. The communication device may be communicatively connected to a central office by standard telephone wire. The central office may be communicatively connected, either wirelessly or non-wirelessly, with a plurality of other remote communication devices, such as an emergency service, a hand held personal digital assistant (PDA), a cellular phone, or the like.

The detector may include a power supply, a test switch, a sensor(s), a visual indicator(s), an audible indicator(s), a transmitter/receiver, an antenna, and associated electronic wiring. These elements may all be interconnected with a microprocessor that can be any of well-known and commercially available integrated circuits and may be comprised of a central processing unit(s) and program memory and data memory, which would allow the microprocessor to execute program instructions. The detector may also include a case or housing configured according to the desires of the user. The detector may be configured to operate on regulated DC power.

The sensor may be any type of sensor for monitoring a particular parameter, such as a fire, an intrusion, a movement, or the like. For example, the sensor may be a temperature sensor, a smoke sensor, a water level sensor, a light sensor, a contact sensor, a motion sensor, an infrared sensor, an acoustic sensor, an acceleration sensor, a hydrometer sensor, a wind-speed sensor, or the like. The sensor may communicate with the communication device by any known protocol standard.

The sensor may be connected to conventional circuitry that compares the level of the condition signal therefrom with a reference signal. When the condition signal level equals or exceeds the reference signal, the circuitry may output a signal, which may be either analog or digital in form, to activate any connected indicators.

The visual indicator may be configured to emit a light signal. The visual indicator may be a light emitting diode or the like. The audible indicator may be configured to emit an alarm sound signal. The audible indicator may be a solid state type of audible signaling device. Such devices are well known and are capable of emitting a loud sound.

The test switch may be connected to other components of the smoke detector and may include a timer whereby pressing the test switch would cause the indicators to be active for a predetermined amount of time to test the indicator operability of the detector. The reset switch may be connected to other components of the detector whereby pressing the reset switch would cause the sensor, indicators, and the transmitter/receiver to be inactive.

The transmitter/receiver may be of a type well known in the art and may be constructed of miniaturized solid state components that permit the assembly of these components into a transmitter/receiver unit small enough in size to be removably received in a small sized detector housing. The transmitter/receiver may establish a two-way wireless communications link between the detector and the communication device by way of the antenna.

The communication device may include a power supply, a telephone dialer, communication logic, a remote deactivator, a remote activator, memory, a microprocessor, a transmitter/receiver, and an antenna. The communication device may be configured in the form of a telephone jack adapter for inserting into any conventional telephone wall jack. Such a telephone jack adapter may include a front side defining an open telephone jack and a rear side defining a rearwardly projecting telephone plug. Alternatively, the communication device may be configured in the form of a wall plate including a telephone jack. Such a wall plate may be either stamped out of sheet metal, molded from a resin material, or made of wood, ceramic, or the like. The telephone jack would be attached to a wall surface with screws or brackets. The telephone jack may be configured for being powered by current supplied through the standard telephone line rather than by batteries or an AC adapter. Alternatively, batteries, utility power or the like can be used.

The power supply may be power supplied to the communication device from current supplied through a standard telephone line rather than by batteries or an AC adapter. Alternatively, batteries, utility power or the like may be used. The telephone dialer, communication logic, memory, and microprocessor may each be of a type well known in the art. The remote deactivator and the remote activator may be switching circuitry that enables the communication device to activate or deactivate the telephone dialer and associated circuitry upon receipt of a corresponding signal by the transmitter/receiver by a remote control device such as a television remote control, a key ring remote, or the like. Alternatively, the communication device may be wired directly to a remote switching device such as a wall switch, a light switch, or the like. The telephone dialer, communication logic, remote deactivator, remote activator, memory, and microprocessor may all be constructed of miniaturized solid state components that permit the assembly of these components onto a single printed circuit board.

Accordingly, it is a principal aspect of the invention to provide a condition awareness system that includes at least one detector and a communication device that are communicatively connected by a wireless communication link.

It is another aspect of the invention to provide a condition awareness system that includes a communication device with a telephone dialer powered by current from standard telephone wire.

It is a further aspect of the invention to provide a condition awareness system that can be remotely activated and deactivated.

It is an aspect of the invention to provide improved elements and arrangements thereof in a condition awareness system for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is functional diagram of a condition awareness system according to the present invention.

FIG. 2 is a block diagram of a detector according to the present invention.

FIG. 3 is a block diagram of a communication device according to the present invention.

Similar reference characters denote corresponding features consistently throughout the attached drawings.

### DETAILED DESCRIPTION OF THE PREFERRED EMBODIMENTS

This invention relates to condition awareness systems. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

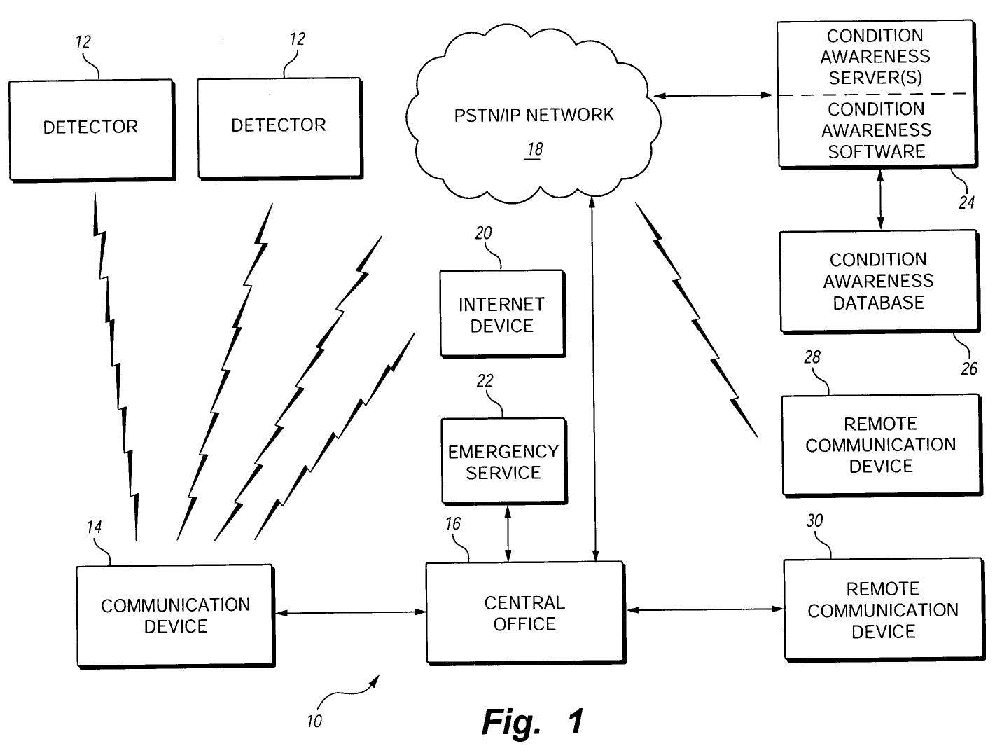

Referring to the drawings, FIG. 1 shows a condition awareness system of the invention. The condition awareness system 10 includes at least one detector and a communication device, generally designated in the figures with reference numerals 12 and 14, respectively. The detectors 12 may be communicatively connected to communication device 14 by a wireless communication link.

The condition awareness system 10 may also include a condition awareness website administered by a condition awareness server 24 and a condition awareness database 26. The condition awareness server 24 may include stored therein condition awareness software. The condition awareness software may be stored in a server memory which may be any combination of random access memory or cache memory. The condition awareness server 24 includes a processor, an operating system, application programs, and data. In accordance with well known principles, the processor executes the applications in the condition awareness server memory under control of the operating system.

The condition awareness system may be configured for enabling a user to independently and unilaterally manage and operate the detectors 12 and the communication device 14 according to the desires of the user. The condition awareness system 10 may also be configured for enabling a user to partially manage and operate the detectors 12 and the communication device 14 in association with a remote system operator and/or operator. In other words, the user may purchase the detectors, the communication device 14, and the communication software from a retail outlet, and may then subscribe to a remote condition awareness service that alerts the user and/or third parties based on detector activation in accordance with the desires of the user.

The condition awareness system 10 may also be configured for complete and unilateral control of detectors 12, a communication device, and condition awareness software by a condition awareness service that installs, manages, and operates the condition awareness system 10 for a user without the ability of the user to effect any management and/or control capabilities with the exception of subscribing to the service.

Communication device 14 may be communicatively connected to a central office 16 by a wireline (e.g., via standard telephone wire) and/or a wireless communication link (e.g., via the Internet). Central office 16 may be communicatively connected, either by wirelessly or non-wirelessly, with a plurality of other remote communication devices, such as emergency service 18, remote communication device 20, remote communication device 22, or the like. Remote communication devices 20 and 24 may be any known type of communication device, such as a hand held PDA, a cellular phone, a friend's phone, or the like.

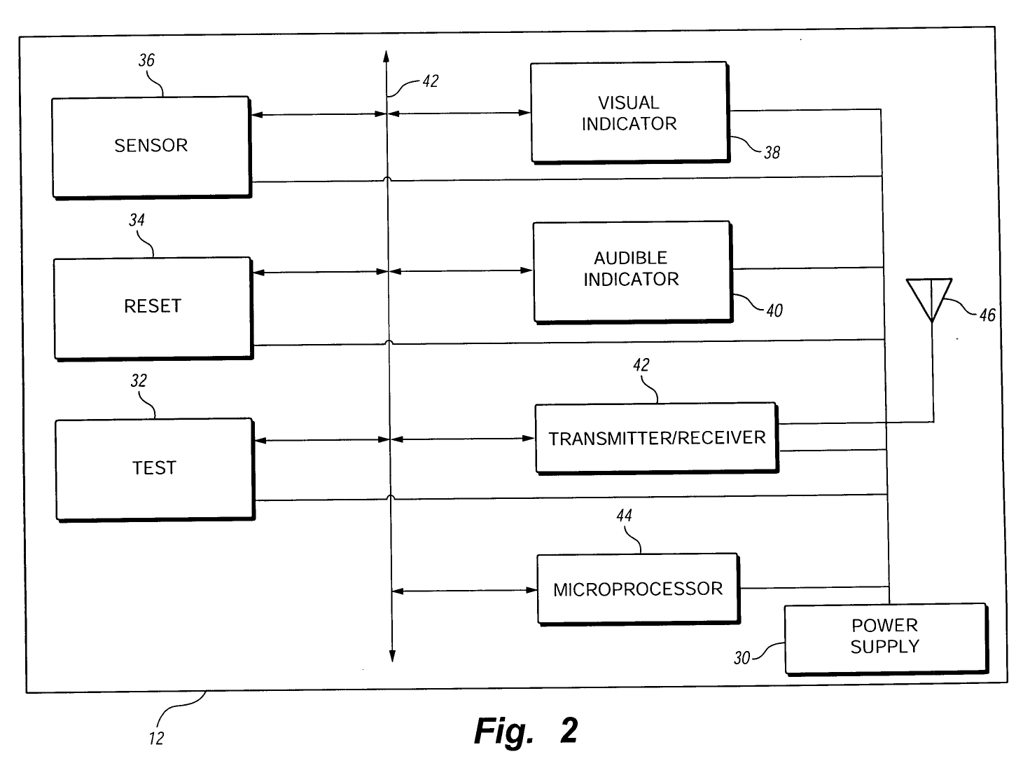

As illustrated in FIG. 2, detector 12 may include power supply 30, test switch 32, reset switch 34, at least one sensor 36, visual indicator 38, audible indicator 40, transmitter/receiver 42, antenna 44, and associated electronic wiring. These elements may all be interconnected over a communication bus 42 with a microprocessor 44 that may be any of well-known and commercially available integrated circuits and may be comprised of at least a central processing unit and program memory and data memory, which would allow the microprocessor to execute program instructions as described in greater detail below. Detector 12 may also include a case or housing (not shown) configured according the desires of the user. Detector 12 may be configured to operate on regulated DC power. Therefore, power supply 30 may correspond to either DC power, such as a battery or the like, or AC power, such as utility power or the like, that has been transformed to DC power.

Sensor 36 may be any type of sensor for monitoring a particular parameter, such as a fire, an intrusion, a movement, or the like. For example, sensor 36 may be a temperature sensor, a smoke sensor, a water level sensor, a light sensor, a contact sensor, a motion sensor, an infrared sensor, an acoustic sensor, an acceleration sensor, a hydrometer sensor, a sonic sensor, a wind-speed sensor, or the like. Sensor 36 may communicate with communication device 14 by any known protocol standard.

Sensor 36 may be connected to conventional circuitry (not shown) that compares the level of the condition signal therefrom with a reference signal. When the condition signal level equals or exceeds the reference signal, the circuitry may output a signal, which may be either analog or digital in form, to activate any connected indicators 38,40.

Visual indicator 38 may be configured to emit a light signal. Visual indicator 38 may be a light emitting diode or the like. Audible indicator 40 may be configured to emit an alarm sound signal, such as a bell, a horn, a siren, or the like. Audible indicator 40 may be a solid state type of audible signaling device. Such devices are well known and are capable of emitting a loud sound.

Transmitter/receiver 42 may be a transmitter/receiver of any type known in the art may be constructed of miniaturized solid state components that permit the assembly of these components into a transmitter/receiver unit small enough in size to be removably received in a small sized detector housing. Transmitter/receiver 42 may establish a two-way wireless communications link between detector 12 and communication device 14 by way of antenna 44 and electromagnetic signals, such as those in the radio frequency range, for example. The format of the electromagnetic signals communicated between detector 12 and communication device 14 may be either analog or digital. Alternatively, the electromagnetic signals may be infrared signals.

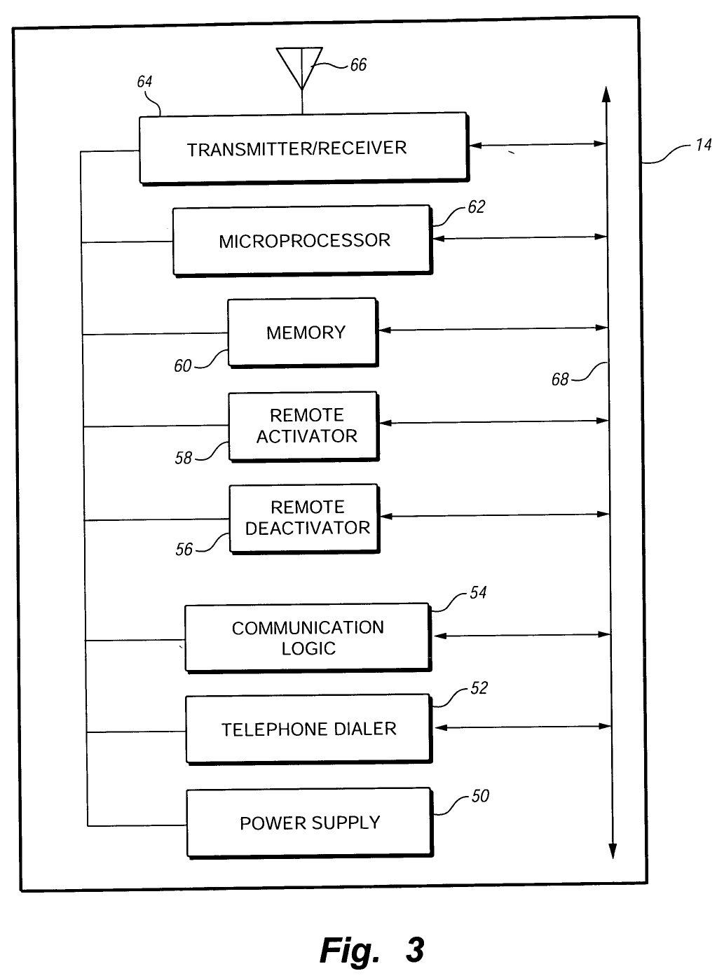

As illustrated in FIG. 3, communication device 14 may include power supply 50, telephone dialer 52, communication logic 54, remote deactivator 56, remote activator 58, memory 60, microprocessor 62, transmitter/receiver 64, antenna 66, and communication bus 68. Communication device 14 may be configured in the form of a telephone jack that would be attached to a wall surface with screws or brackets.

Telephone dialer 52, communication logic 54, memory 60, microprocessor 62, and communication bus 68 may each be of a type well known in the art. Remote deactivator 56 and remote activator 58 may be switching circuitry that enables communication device 14 to activate or deactivate the telephone dialer and associated circuitry upon receipt of a corresponding signal by transmitter/receiver 64 by a remote control device such as a television remote control, a key ring remote, or the like. Telephone dialer 52, communication logic 54, remote deactivator 56, remote activator 58, memory 60, and microprocessor 62 may all be constructed of miniaturized solid state components that permit the assembly of these components onto a single printed circuit board.

The following summarizes the operation of the condition awareness system shown in FIGS. 1-3. Detectors 12 monitor a particular parameter, such as a fire, an intrusion, a movement, or the like. Upon detection of undesired parameter, detector 12 may activate visual indicator 38, audible indicator 40, and/or emit a wireless signal via transmitter/receiver 42 to communication device 14. Communication device 14 may evaluate the signal received from detector 12 and take appropriate action with respect to telephone dialer 52. When microprocessor 62. detects or recognizes an undesired parameter condition based on signals received from detector 14, microprocessor 62 may activate a timer for a predetermined amount of time. The individual may then cause a remote control device, such as a television remote control, a key ring remote, or the like, to emit a deactivation signal to detector 12 and communication device 14 to deactivate detector 12 and communication device 14.

While the invention has been described with reference to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A detector for use in a condition awareness system, said detector comprising:
a power supply;
at least one sensor;
an indicator;
a transmitter/receiver; and
an antenna.

2. The detector according to claim 1, wherein said at least one sensor is selected from the group consisting of a temperature sensor, a smoke sensor, a water level sensor, a light sensor, a contact sensor, a motion sensor, an infrared sensor, an acoustic sensor, an acceleration sensor, a sonic sensor, a hydrometer sensor, and a wind-speed sensor.

3. The detector according to claim 1, further comprising a test switch and a reset switch.

4. The detector according to claim 1, wherein said indicator is a visual indicator.

5. The detector according to claim 1, wherein said indicator is an audible indicator.

6. The detector according to claim 1, wherein said transmitter/receiver is configured to operate wirelessly with electromagnetic signals.

7. The detector according to claim 1, wherein said detector is configured to operate on regulated DC power.

8. A communication device for use in a condition awareness system, said communication device comprising:
a telephone dialer;
communication logic;
memory;
a microprocessor;
a transmitter/receiver; and
an antenna.

9. A condition awareness system comprising:
a detector comprising:
a power supply;
at least one sensor;
an indicator;
a first transmitter/receiver; and
a first antenna; and
a communication device comprising:
a telephone dialer;
communication logic;
memory;
a microprocessor;
a second transmitter/receiver; and
a second antenna.

10. The condition awareness system according to claim 9, wherein said at least one sensor is selected from the group consisting of a temperature sensor, a smoke sensor, a water level sensor, a light sensor, a contact sensor, a motion sensor, an infrared sensor, an acoustic sensor, an acceleration sensor, a hydrometer sensor, and a wind-speed sensor.

11. The condition awareness system according to claim 9, further comprising a test switch and a reset switch.

12. The condition awareness system according to claim 9, wherein said indicator is a visual indicator.

13. The condition awareness system according to claim 9, wherein said indicator is an audible indicator.

14. The condition awareness system according to claim 9, wherein said transmitter/receivers are configured to operate wirelessly with electromagnetic signals.

15. The condition awareness system according to claim 9, wherein said detector is configured to operate on regulated DC power.

16. The condition awareness system according to claim 9, further comprising a condition awareness website administered by a condition awareness server and a condition awareness database.
